(19) United States
(12) Patent Application Publication
(10) Pub. No.: US 2011/0250493 A1
(43) Pub. Date: Oct. 13, 2011

(54) BATTERY PARTS AND ASSOCIATED METHODS OF MANUFACTURE AND USE

(75) Inventors: Andrea Balzan, (US); Giuseppe Segreto, Patti (IT); Michael A. Garin, Mahotmedi, MN (US)

(73) Assignee: Water Gremlin Company, White Bear Lake, MN (US)

(21) Appl. No.: 13/046,649

(22) Filed: Mar. 11, 2011

Related U.S. Application Data
(60) Provisional application No. 61/313,534, filed on Mar. 12, 2010.

(51) Int. Cl. H01M 2/30

(52) U.S. Cl. 429/179; 429/180; 429/181; 29/874

(57) ABSTRACT

Battery parts, such as battery terminals and bushings, and associated methods of manufacture and use are described herein. In one embodiment, a battery terminal can include one or more features for reducing weight and using less lead or other raw material. These features can include, for example, a plurality of longitudinal channels or recesses formed in an interior surface portion of the battery part.

### CROSS-REFERENCE TO RELATED APPLICATION

The present application claims priority under 35 USC §119(e) to U.S. Provisional Application No. 61/313,534, filed Mar. 12, 2010, the disclosure of which is incorporated herein by reference in its entirety.

### APPLICATIONS INCORPORATED BY REFERENCE

U.S. Patent Application No. 61/174,344, filed Apr. 30, 2009 and entitled “BATTERY PARTS HAVING RETAINING AND SEALING FEATURES AND ASSOCIATED METHODS OF MANUFACTURE AND USE;” U.S. patent application Ser. No. 12/533,413, filed Jul. 31, 2009 and entitled “BATTERY PARTS AND ASSOCIATED SYSTEMS AND METHODS;” and International Application No. PCT/US2008/064161, filed May 19, 2008 and entitled “BATTERY PARTS AND ASSOCIATED METHODS OF MANUFACTURE AND USE;” are incorporated herein in their entireties by reference.

### TECHNICAL FIELD

The following disclosure relates generally to battery parts and, more particularly, to lead battery terminals, battery terminal bushings, and the like.

### BACKGROUND

Battery terminals are typically cold formed or cast from lead or lead alloys. In a conventional lead-acid battery, the terminals protrude from a casing or container which carries electrolyte. The container is typically formed from a moldable resin, such as thermoplastic resin, polypropylene and the like. During manufacture of the container, the uncured resin flows around the base of the terminals so that the resin secures the terminals in place once it hardens. After the terminals have been secured in place, a lead anode can be inserted into a central hole in the terminal and melted to fill the hole and form a mechanical and electrical connection to a battery grid positioned within the container.

Battery terminals can include annular rings that extend around the base of the terminal to provide an extended interface between the base of the terminal and the adjacent container material. This interface can provide a torturous path or “labyrinth seal” that inhibits or prevents acid or electrolyte from escaping the battery container. Conventional battery terminals can also become loose in the surrounding container material if subjected to repeated or excessive twisting or torsional loads. Additionally, shrinkage of the battery container may also contribute to loosening of the terminals over time. Accordingly, it would be advantageous to provide battery terminals and/or other battery parts that address these shortcomings.

### BRIEF DESCRIPTION OF THE DRAWINGS

FIG. 1A is a side elevation view of a battery part configured in accordance with an embodiment of the disclosure, and FIG. 1B is an end view of the battery part.

FIG. 2 is an enlarged, cross-sectional side view of the battery part of FIGS. 1A and 1B, taken substantially along line 2-2 in FIG. 1B.

FIG. 3 is an enlarged cross-sectional side view of a portion of the battery part of FIG. 2, illustrating a lightening recess or channel configured in accordance with an embodiment of the disclosure.

FIG. 4 is a cross-sectional side elevation view illustrating a battery assembly having a battery part installed in a battery container in accordance with an embodiment of the disclosure.

### DETAILED DESCRIPTION

The following disclosure describes various embodiments of battery parts, such as lead-acid battery terminals, bushings, and the like, and associated methods of manufacture and use. In one embodiment, a battery terminal configured in accordance with the present disclosure includes one or more features that reduce part weight. Such features can include, for example, a series of longitudinal grooves or channels that can be formed in an interior surface of the battery terminal during manufacture. In other embodiments, battery terminals configured in accordance with the present disclosure can include other features to reduce weight and/or save on material. Such features can include, for example, various types of notches, recesses, channels, etc. having rectangular shapes, non-circular shapes, partially-circular shapes, symmetrical shapes, non-symmetrical shapes, irregular shapes, flat surface portions, concave surface portions, convex surface portions, etc.

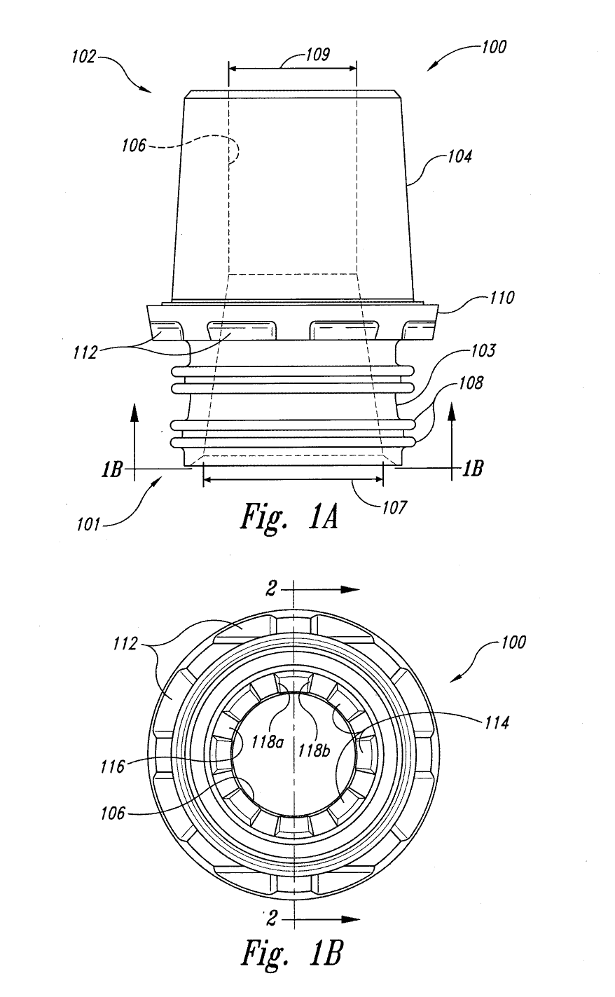

Certain details are set forth in the following description and in FIGS. 1-4 to provide a thorough understanding of various embodiments of the invention. Other details describing well-known structures and systems often associated with batteries, lead-acid batteries, and associated battery parts (e.g., lead and/or lead alloy battery parts, moldable battery containers, etc.), and methods for forming such parts (e.g., forming, casting, injection molding, etc.), as well as other battery parts and assemblies, are not set forth in the following disclosure to avoid unnecessarily obscuring the description of the various embodiments of the invention.

Many of the details, dimensions, angles and/or other portions shown in the Figures are merely illustrative of particular embodiments of the invention. Accordingly, other embodiments can have other details, dimensions, angles and/or portions without departing from the spirit or scope of the present invention. In addition, further embodiments of the invention may be practiced without several of the details described below, while still other embodiments of the invention may be practiced with additional details and/or portions.

In the Figures, identical reference numbers identify identical or at least generally similar elements. To facilitate the discussion of any particular element, the most significant digit or digits of any reference number refers to the Figure in which that element is first introduced. For example, element 110 is first introduced and discussed with reference to FIG. 1.

FIG. 1A is a side elevation view of a battery part 100 configured in accordance with an embodiment of the disclosure, and FIG. 1B is an end view of the battery part 100. Referring to FIGS. 1A and 1B together, in the illustrated embodiment the battery part 100 is a battery terminal (or “terminal bushing”) having a lug portion 104 extending from a base portion 103. The lug portion 104 can have a variety of different shapes known in the art (e.g., a tapered cylindrical shape) suitable for attachment to a cable clamp or other suitable connector. As described in greater detail below, the base portion 103 can be configured to be fixedly embedded in battery container material during formation of the battery container or lid (not shown in FIG. 1A). The battery part 100 can be formed from lead, lead alloy, and/or other suitable materials by forming (e.g., cold-forming, cold-forming with a segmented mold, hot-forming, roll-forming, stamping, etc.), casting (e.g., die casting), forging, machining, and/or other suitable methods known in the art.

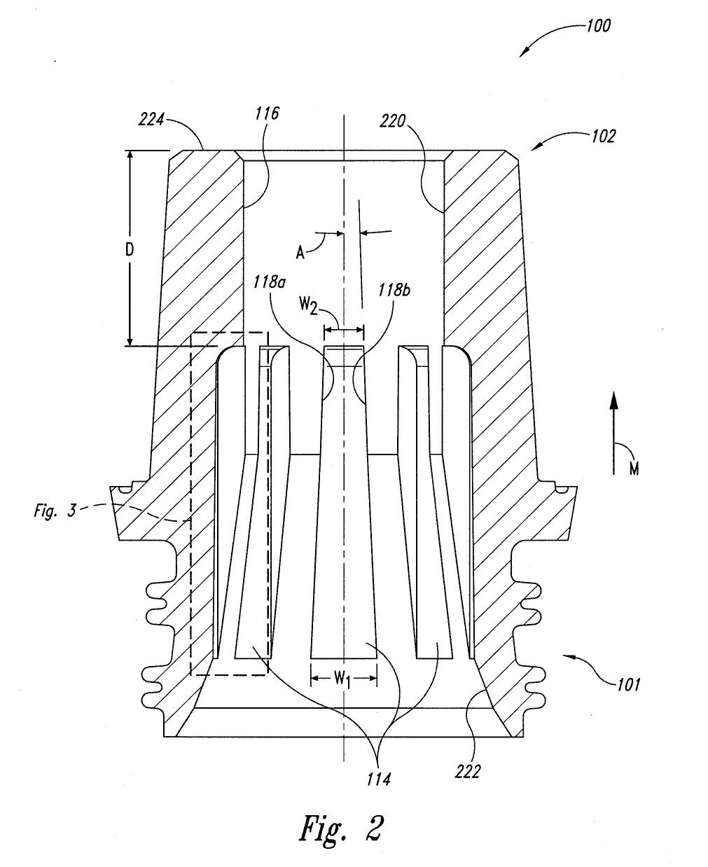

The battery part 100 can also include a passage or through-hole 106 extending through the battery part 100 from a first end portion 101 to a second end portion 102. In the illustrated embodiment, the passage or through-hole 106 can have a first opening 107 proximate the base portion 103 and a second opening 109 proximate the lug portion 104. The first opening 107 can have a first diameter from about 0.2 inch to about 0.9 inch or about 0.55 inch, and the second opening 109 can have a second diameter from about 0.3 inch to about 0.6 inch, or about 0.4 inch. Flaring the through-hole 106 toward the distal end of the base portion 103 as shown in FIG. 2 can advantageously reduce the amount of lead required to make the battery part 100, in addition to favorably reducing the weight of the part 100.

In one aspect of this embodiment, the base portion 103 can include one or more annular sealing rings 108 (e.g., acid-sealing rings). The sealing rings 108 can form a tortuous path-type seal to inhibit or prevent electrolyte or acid (e.g., sulfuric acid) from escaping from the battery container during use. In other embodiments, battery parts configured in accordance with the present disclosure can include other types of sealing portions, sealing rings, and/or other sealing features that extend around, or at least partially around the base portion 103. In addition or alternatively, in further embodiments one or more of the sealing rings 108 may be omitted.

In another aspect of this embodiment, the battery part 100 includes a generally annular flange 110 extending outwardly between the base portion 103 and the lug portion 104. In the illustrated embodiment, the flange 110 can include a plurality of locking features or torque-resisting features 112. For example, in the illustrated embodiment, the torque-resisting features 112 include a plurality of recesses or notches formed in a lower surface portion of the flange 110. As described in greater detail below, the base portion 103 and at least a portion of the flange 110 can be encased in battery container material during formation of the battery container or, more particularly, a container lid or cover. After the battery container material has hardened, the torque-resisting features 112 can grip the container material and resist rotation of the battery part 100 when it is subjected to a twisting or torsional load during use.

In a further aspect of this embodiment, the battery part 100 can also include a plurality of weight-saving features formed in an interior sidewall 116 of the through-hole 106. More specifically, in the illustrated embodiment the battery part 100 includes a plurality (e.g., eight) longitudinal channels or recesses 114 formed in the interior sidewall 116. The recesses 114 are equally spaced around the inner circumference of the through-hole 106. In other embodiments, the battery part 100 and/or other battery parts configured in accordance with the present disclosure can include more or fewer recesses in different spacing and/or orientations around the interior surface 116.

FIG. 2 is an enlarged cross-sectional side elevation view of the battery part 100 taken substantially along line 2-2 in FIG. 1B. Referring to FIGS. 1B and 2 together, in the illustrated embodiment each of the recesses 114 includes a first sidewall portion 118a spaced apart from an opposing second sidewall portion 118b. The sidewall portions 118 can taper slightly inward as they extend toward the second end portion 102 to provide a slight draft angle A that facilitates removal of the battery part 100 from a suitable forming tool or mold during manufacture. More specifically, in some embodiments the recesses 114 can be formed by a central forming tool (not shown) having a plurality of outwardly-projecting spines, ridges, or other suitable features that form the recesses 114 when the battery part 100 is formed around the tool during manufacture. In these embodiments, the slight draft angle A can facilitate removing the battery part 100 from the tool in the direction M after forming. In the illustrated embodiment, the draft angle A can be between about 1° and about 5°, such as about 2-3°. In other embodiments, the other draft angles A can be used to facilitate formation of the battery part 100.

In the illustrated embodiment, each of the recesses 114 can have a first width W₁ toward the first end portion 101 and a second, narrower width W₂ toward the second end portion 102. For example, in the illustrated embodiment the first W₁ can be from about 0.06 inch to about 0.12 inch, or about 0.1 inch, and the second width W₂ can be from about 0 inch to about 0.12 inch, or about 0.06 inch. Moreover, in the illustrated embodiment the recesses 114 can be positioned a distance D below an end surface 224 of the second end portion 102. For example, in the illustrated embodiment the distance D can be from about 0.04 inch to about 0.8 inch, or about 0.4 inch. In other embodiments, the recesses 114 can have other shapes, sizes, and positions on the battery part 100.

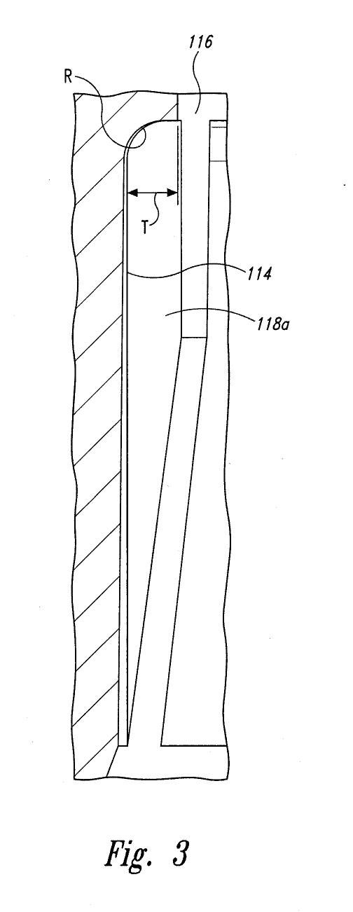

FIG. 3 is an enlarged side cross-sectional view of a portion of the battery part 100 taken from FIG. 2 for the purpose of illustrating additional details of the recesses 114. As shown in FIG. 3, each of the recesses 114 can include a generous radius R at a distal end thereof. The radius R can facilitate removal of the battery part 100 from the forming tool and/or mold during manufacture, and can reduce stress cracks in the part during use. In the illustrated embodiment, the radius R can be from about 0.005 inch to about 0.1 inch, or about 0.04 inch. Moreover, in the illustrated embodiment, each of the recesses 114 can have a depth T from about 0.02 inch to about 0.1 inch, or about 0.06 inch to about 0.08 inch. The recesses 114 can have generally rectangular cross-sectional shapes, and/or cross-sectional shapes in which the sidewalls 118a, b open slightly outward toward the center of the battery part 100. The slight outward angle between the sidewalls 118 can facilitate removal of the battery part 100 from the tool or mold during formation. In other embodiments, the recesses 114 can have other shapes, sizes, positions and/or orientations in the battery part 100 without departing from the spirit or scope of the present disclosure. For example, in other embodiments, the recesses 114 and/or suitable variations thereof can have V-shaped cross-sections.

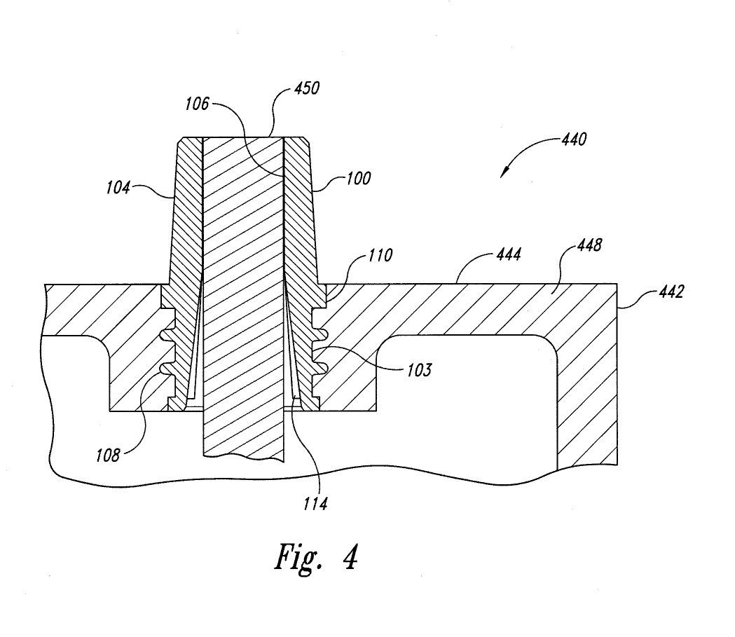

FIG. 4 is a side cross-sectional view of a portion of a battery assembly 440 configured in accordance with an embodiment of the invention. In one aspect of this embodiment, the battery part 100 is fixedly attached to a battery casing or container 442 (e.g., a top cover of a battery container) so that the lug portion 104 is exposed and accessible for attachment to a suitable connector, such as a clamp or other cable connector (not shown). The battery container 442 can be formed from a moldable material 448, such as polypropylene, polyethylene, other plastics, thermoplastic resins, and/or other suitable materials known in the art. During manufacture of the battery assembly 440, molten container material 448 can be flowed around the base portion 103 of the battery part 100 so that the flange 110 is embedded in the container material 448 adjacent to an outer surface portion 444. The container material 448 also encases the sealing rings 108 to create a seal that can prevent or at least inhibit liquid, e.g., electrolyte, acid, water, etc. from escaping the battery container 442. After the battery part 100 has been secured to the battery container 442 as illustrated in FIG. 4, the through-hole 106 can be filled with a post 450 and/or molten lead or other suitable material to form a mechanical and electrical connection to a battery grid (not shown) within the battery container 442. In the illustrated embodiment, the recesses 114 do not extend all the way to the top of the through-hole 106 to avoid having any significant gaps or openings between the post 450 and the sidewall of the through-hole 106. In one aspect of this embodiment, after assembly, at least a portion of each of the recesses 114 remains open; that is, at least a portion of each of the recesses 114 is not filled with lead.

The recesses 114 and suitable variations thereof described herein provide a way to reduce the weight of battery terminals and related parts without appreciably compromising the strength of the part or increasing the manufacturing cost. The various battery parts described above can be manufactured from lead, lead alloys, and/or other suitable materials known to those of ordinary skill in the art. In addition, these parts can be manufactured by any suitable manufacturing method such as casting, die casting, cold forming, roll forming, stamping, forging, machining, etc. For example, in one embodiment, the battery parts described herein can be formed by cold-forming with a segmented mold, such as a segmented mold having two segments. In addition, various embodiments of the battery parts described herein can be formed in accordance with methods disclosed in, and can include features at least generally similar to, those disclosed in U.S. Pat. No. 5,349,840, which is incorporated herein in its entirety by reference.

From the foregoing, it will be appreciated that specific embodiments of the invention have been described herein for purposes of illustration, but that various modifications may be made without deviating from the spirit and scope of the various embodiments of the invention. For example, although many of the Figures described above illustrate battery parts having cylindrical portions (e.g., cylindrical lug portions, base portions, sealing rings, through-holes, etc.), in other battery parts configured in accordance with the present disclosure these portions can have one or more flat sides and/or other non-cylindrical surfaces. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

1.-3. (canceled)

4. A battery part comprising:
a base portion configured to be fixedly embedded in battery container material adjacent to an outer surface of a battery container;
a lug portion extending from the base portion;
a hole extending through the lug portion and the base portion; and
a plurality of weight-saving recesses formed in an interior sidewall of the hole.

5. The battery part of claim 4 wherein the base portion includes one or more annular sealing rings configured to be fixedly embedded in the battery container material to prevent fluid from escaping from the battery container during use.

6. The battery part of claim 4 wherein the plurality of weight-saving recesses includes a plurality of longitudinal recesses formed in the sidewall of the hole.

7. The battery part of claim 4 wherein the plurality of weight-saving recesses includes a plurality of longitudinal recesses formed in the sidewall of the hole and equally spaced around a circumference of the hole.

8. The battery part of claim 4 wherein the hole is a through-hole that extends from a first opening proximate the base portion to a second opening proximate the lug portion, and wherein the plurality of weight-saving recesses do not extend to the second opening.

9. The battery part of claim 4 wherein the hole is a through-hole having an outwardly-tapered portion proximate the base portion and a cylindrical portion proximate the lug portion, and wherein the plurality of weight-saving recesses includes a plurality of longitudinal channels formed in a sidewall of the tapered portion.

10. The battery part of claim 4 wherein the plurality of weight-saving recesses includes a plurality of longitudinal recesses formed in the sidewall of the hole, and wherein the individual recesses have a first width toward the base portion and a second, narrower width toward the lug portion.

11. The battery part of claim 11 wherein the plurality of weight-saving recesses includes a plurality of longitudinal recesses formed in the sidewall of the hole, wherein the individual recesses include a first sidewall portion spaced apart from an opposing second sidewall portion, wherein the first and second sidewall portions taper inwardly as they extend toward the lug portion, and wherein the first and second sidewall portions open slightly outward toward a center of the battery part to facilitate removal of the battery part from a forming tool during manufacture.

12. A battery part comprising:
a base portion having one or more annular sealing rings configured to be encased in battery container material;
a lug portion extending from the base portion;
a flange extending outwardly between the base portion and the lug portion;
a plurality of torque-resisting features formed in the flange and configured to resist rotation of the battery part when subjected to a twisting force;
a hole extending through the lug portion and the base portion; and
a plurality of channels formed in a sidewall of the hole.

13. The battery part of claim 12 wherein the torque-resisting features include a plurality of notches formed in a surface portion of the flange.

14. The battery part of claim 12 wherein the plurality of channels includes a plurality of longitudinal channels formed in the sidewall of the hole, and wherein the individual channels include a first sidewall portion spaced apart from an opposing second sidewall portion, and wherein the first and second sidewall portions taper inwardly toward each other as they extend toward the lug portion.

15. The battery part of claim 14 wherein the first and second sidewall portions taper inwardly as they extend toward the lug portion to define a slight draft angle to facilitate removal of the battery part from a forming tool during manufacture, and wherein the draft angle is from about 1 degree to about 5 degrees.

16. The battery part of claim 12 wherein the individual channels include a first sidewall portion spaced apart from an opposing second sidewall portion, wherein the first and second sidewall portions open slightly outward toward a center of the battery part to facilitate removal of the battery part from a forming tool during manufacture.

17. The battery part of claim 12 wherein the hole is a through-hole that extends from a first opening proximate the base portion to a second opening proximate the lug portion, wherein the plurality of channels includes a plurality of longitudinal channels formed in a conical surface proximate the base portion, and wherein the longitudinal channels do not extend to the second opening.

18. A method of forming a battery part, the method comprising:
forming a base portion and a lug portion from at least one of lead or lead alloy; and
forming a hole through at least the base portion, wherein forming the hole includes forming a plurality of grooves in a sidewall of the hole by disposing at least one of the lead or lead alloy around a forming tool, wherein the forming tool includes a plurality of outwardly-projecting features that form the grooves in the sidewall of the hole.

19. The method of claim 18 wherein forming a hole includes forming a central hole extending longitudinally through the base portion and the lug portion.

20. The method of claim 18 wherein forming a plurality of grooves in a sidewall of the hole includes cold-forming the lead or lead alloy around the forming tool.

21. The method of claim 18 wherein forming a plurality of grooves in a sidewall of the hole includes casting the lead or lead alloy around the forming tool.

22. The method of claim 18 wherein forming a plurality of grooves in a sidewall of the hole includes disposing at least one of the lead or lead alloy around a forming tool having a plurality of outwardly-projecting ridges.

23. The method of claim 18 wherein forming a plurality of grooves in a sidewall of the hole includes forming a plurality of longitudinal grooves having a first width toward the base portion and a second, narrower width toward the lug portion.
